(19) United States
(12) Patent Application Publication
(10) Pub. No.: US 2012/0233906 A1
(43) Pub. Date: Sep. 20, 2012

(54) CONTAINER WITH PARTICULAR APPLICATION AS A BURLEY POT

(75) Inventor: Michael Bernarde Leister, Port Adelaide (AU)

(73) Assignee: L & L (SA) PTY LTD, Port Adelaide (AU)

(21) Appl. No.: 13/498,433

(22) PCT Filed: Sep. 28, 2010
(86) PCT No.: PCT/AU2010/001294

§ 371 Date: Jun. 1, 2012

(30) Foreign Application Priority Data
Sep. 28, 2009 (AU) 2009904689

(51) Int. Cl. A01K 97/02

(52) U.S. Cl. 43/44.99

(57) ABSTRACT

A burley pot for dispersing burley comprising an outer shell adapted to contain a burley bucket and a removable end cap to sealingly contain the bucket. The pot includes an adjustment means for adjusting the rate at which burley is dispersed by releasably fixing the bucket to the shell at various longitudinal intervals. An integral eye accommodates the attachment of a rope and the like.

### CROSS REFERENCE TO RELATED APPLICATIONS

This application is a National Stage Entry of PCT Application Serial No. PCT/AU2010/001294 having an international application date of Sep. 28, 2010, which application claims priority from Australian Patent Application No. 2009904689, filed Sep. 28, 2009; the disclosures of which are incorporated herein by reference.

### FIELD OF THE INVENTION

The present invention relates to an improved container of the type that when in use can progressively deliver material out of the container and that when not in use is sealed preventing the material leaving the container. In particular the present invention is directed to a container that can be used to deliver burley when in use and when not in use is sealed allowing the container which is effectively a burley bucket to be easily carried without making a mess.

The following description will thus concentrate on the container being used as a burley bucket. It is however to be understood that such a container may have many other applications. For example, it may be used to provide chemical treatment of pools and spas. Thus although directed to a burley container it is not the intention of this application to limit it to that use.

### BACKGROUND OF THE INVENTION

Fishing as a pastime is virtually unsurpassed in popularity with a very significant proportion of the population that includes both sexes and people of all ages. Fishing is thus a pastime with almost a universal appeal. The degree of involvement and commitment to fishing does however vary. Some may take up fishing occasionally during holiday periods whilst the serious sports angler invests considerable time and money in pursuit of fish. All however have common goals of trying to catch fish.

The dispersal of bait (known in Australia as burley or, in some parts of the world as chum) into the water around a fishing area is a well known practise that is used to attract fish to an area. Fish are attracted by the scent of the bait carried on water currents and a more plentiful supply of fish in the fishing area generally results in greater prospects of success.

Burley itself consists of many possible constituents and many fishermen have their own preferred formulations, which are, in some cases a closely guarded secret. Some common ingredients include fish oils, scraps of fish, prawns heads and so on. Frequently the burley has a powerful, fishy odour, and it is often true to say that what is attractive to a fish is not necessarily appealing to the human nose. The need to dispense only moderate quantities of burley over a period of time and the reasonably unattractive nature of the burley product can present the fisherman with some difficulties. Firstly, pots currently available for the distribution of burley typically contain perforations or openings of some form to allow the burley material to be dispensed over an extended time period. Not all of the contents of the pot will necessarily be used in one fishing trip. Because of these perforations, transport and storage of burley pots can present some problems. Leakage of material from a pot is undesirable as this can result in either the burley material itself, or the odour of the burley material dominating the air.

In addition, current burley pots do not enable the amount of burley dispensed to be controlled. Thus burley that easily flows out of the pots results in the time period being much shorter than one may want.

It is an object of the present invention to overcome at least some of the above-mentioned problems or to provide the public with a useful alternative.

### SUMMARY OF THE INVENTION

Therefore according to a first aspect of the present invention there is provided a burley pot for dispersing burley having an outer shell adapted to contain a burley bucket and a removable end cap to sealingly contain the bucket.

Preferably said pot includes an adjustment means to adjust the rate at which burley is dispersed.

In preference said adjustment means comprises releasably fixing the bucket to the shell at various longitudinal intervals.

Preferably said pot includes a locking ring that engages lugs extending from the bucket to thereby fix the bucket in relative longitudinal position to the outer shell.

In preference said pot includes an attachment means to accommodate the attachment of a rope and the like.

Preferably said outer shell has a first end aperture that sealingly engages said bucket and a second end aperture that sealingly engages said end cap.

In preference the engagement of said end cap with said second end aperture causes engagement of said bucket with said first end aperture.

### DESCRIPTION OF DRAWINGS

The above and other objects, features, and advantages of the present invention will be apparent from the following detailed description of a preferred embodiment in conjunction with the accompanying drawings. In the drawings:

FIG. 1 illustrates the sealed burley pot in accordance with a first aspect of the present invention;

FIG. 2 illustrates the separate parts making up the burley pot, being the outer shell, positioning or locking ring, burley bucket and closure cap;

FIG. 3 illustrates the outer shell;

FIG. 4 illustrates the burley bucket;

FIG. 5 illustrates the closure cap;

FIG. 6 illustrates the positioning or locking ring; and

FIG. 7 illustrate a burley pot having a different aspect ratio.

### DESCRIPTION OF THE PREFERRED EMBODIMENT

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts. The current reference numbers are as follows:

10—pot

12—outer covering shell

14—burley bucket

16—positioning or locking ring

18—closure cap

20—burley bucket chamber

22—burley bucket base aperture

24—burley bucket perforated walls

26—burley bucket frustoconical top

28—eye

30—upper aperture of shell

32—O-ring

34—lugs in closure cap

36—apertures in the bucket

38—projections

40—strips

42—cut-outs

44—lugs

46—slits

110—pot (second embodiment)

112—outer covering shell

114—burley bucket

116—positioning or locking ring

118—closure cap

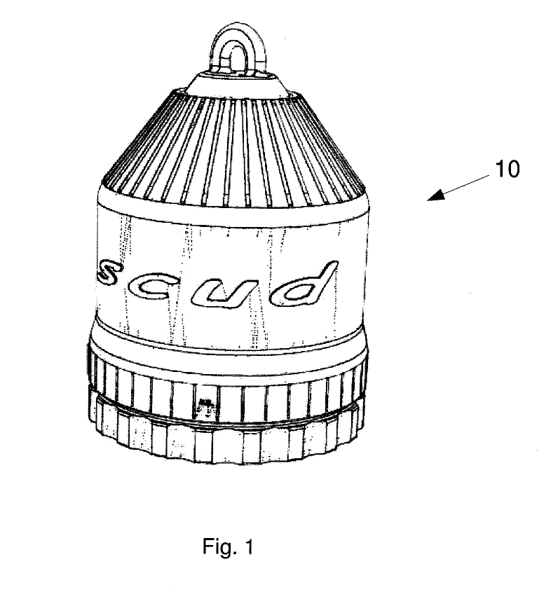

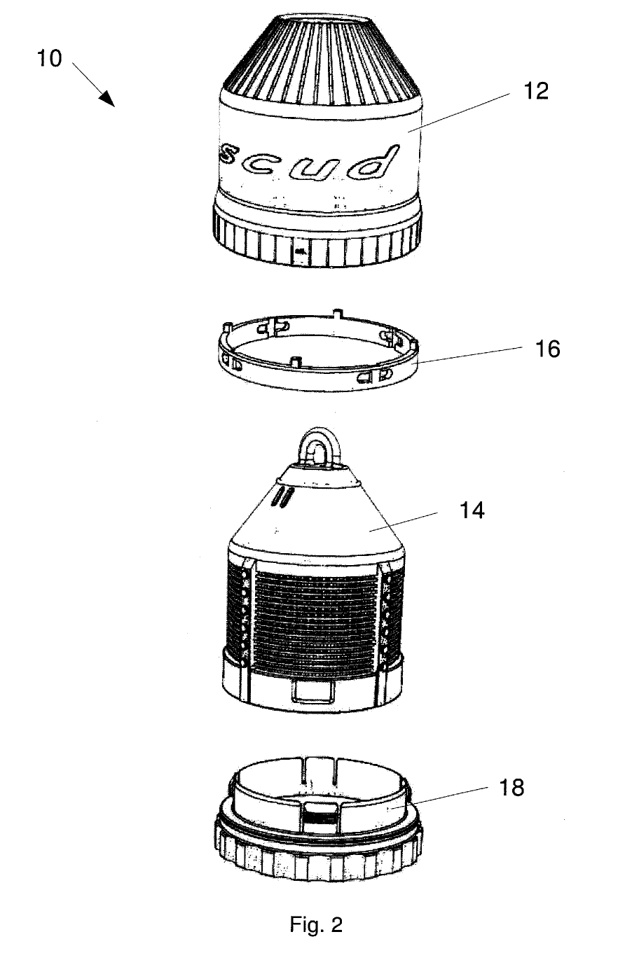

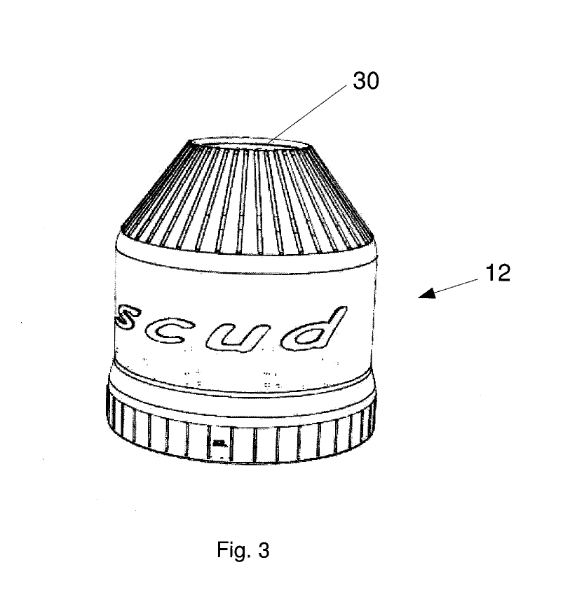

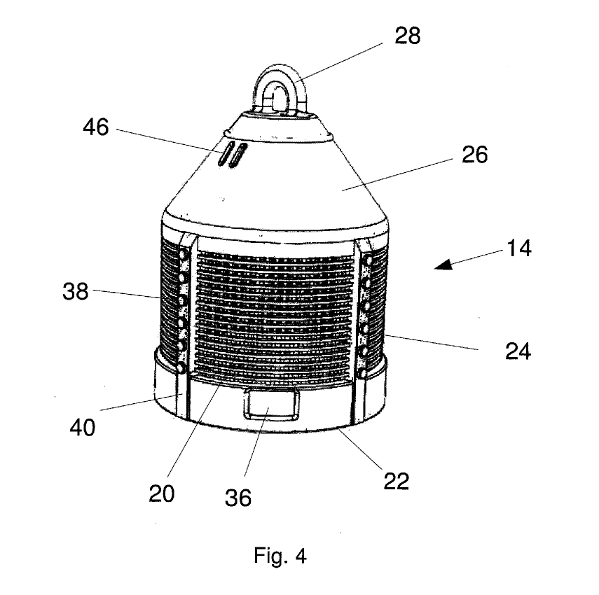

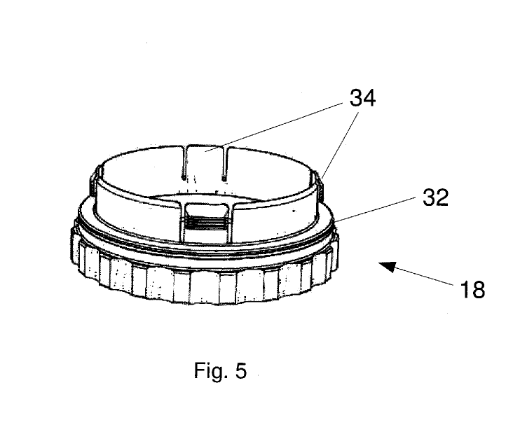

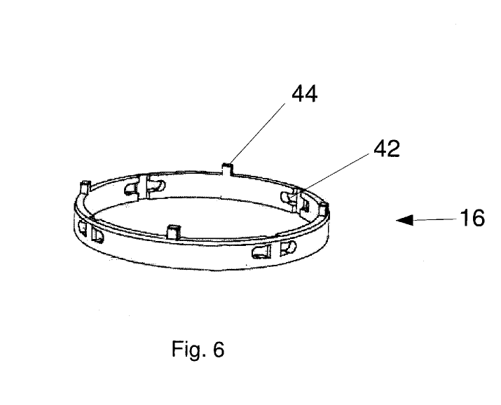

Shown in FIGS. 1-6 is a burley dispenser or pot 10 formed in accordance with a first embodiment of the present invention.

The pot 10 is designed so as to be a self contained apparatus that is in a first configuration adapted to contain burley in a sealed manner and in a second configuration to dispense burley. The pot 10 includes a number of features that enables this to be achieved.

The pot 10 is formed of a number of separate components including an outer covering shell 12, a burley bucket 14, a positioning or locking ring 16 and a closure cap 18. Acting together these elements serve to provide a mechanism for dispensing burley that both controls the rate at which burley may be dispensed from the bucket 14 and also ensures that when not in use the burley is sealed within the pot 10 thus not leaking burley or causing an offensive smell. However not all of these elements are essential and it is not intended to limit the invention to these elements as will be discussed below.

What is essential to the invention is that there be a burley bucket 14 that includes a chamber 20 within which is housed burley (not shown). The bucket typically has a base aperture 22 through which the burley is introduced and perforated walls having multiple apertures 24 through which the burley is dispersed. Typically the bucket 14 is of a cylindrical configuration, but that may not be the case all the time. The top of the bucket 14 may also have varied shapes, in this embodiment being a frustoconical shaped top 26. Extending from the top of the bucket 14 is some kind of an attachment means that allows the pot to be suspended in water. In this case the attachment means is an eye 28 extending from the bucket 14. However the eye 28 may also extend from the outer shell 12 in some configurations.

The outer shell 12 is correspondingly shaped to the bucket 14 or vice versa. Of course that may not be the case, with the only requirement being that the bucket 14 can be contained within the shell 12. The shell 12 includes an upper aperture 30 adapted to enable the tip of the top 26 to protrude there through. Although not shown a seal, such as an 0-ring may be located where the top 26 and the outer shell 12 meet to provide a fluid seal.

When the bucket 14 is fully contained within the shell 12 the closure cap 18 finalises the seal at the bottom of the bucket. The cap 18 includes a double O-ring 32 that engages the shell in an interference fit. Of course, other types of engagement means may very well be used and it is not intended to limit the invention to this type of arrangement. The cap 18 provides sufficient force to also ensure that the seal at the top of the bucket and the shell is maintained in a good configuration. The seals ensure that when the device is taken out of the water no water or burley will escape from it. To assist in handling or screwing the cap it typically may include ridges.

Again, although not essential but preferred the cap 18 may include lugs 34 that engage apertures 36 in the bucket 14 in a snap-type arrangement ensuring that the individual components are releasably locked to each other. Although the lugs as illustrated are circular projections they may equally be of other shapes.

The reader will now appreciate the advantages of the present invention. The burley bucket is contained within the shell when not in use. In order to use it, the cap is removed and the bucket moved downwardly in the shell exposing the burley to the water and thus providing food to the fish.

In order to further improve the invention it may also be desirable to lock the burley bucket 14 in relative position to the shell 12. This can be achieved by many different configurations. One example involves the bucket having projections 38 disposed of symmetrically and circumferentially around the bucket in strips 40. Although there are shown four strips there may be more or less provided that sufficient locking can be achieved. The pot includes a locking ring 16 that includes aperture cut-outs 42 that are adapted to be engaged by the projections 38 when the bucket is rotated with respect to the locking ring. To ensure that the locking ring does not rotate with respect to the shell it includes lugs 44 that engage cut-outs in the outer shell (not shown).

With multiple projections extending down the side of the bucket, the user decides how far to extend the bucket out of the shell and then locks it into place by rotating the bucket with respect to the ring and the outer shell thus effectively locking it into place. Of course, fixing the bucket in the longitudinal direction with respect to the shell may be accomplished by many different engineering solutions such as having biased ball-bearing means, an internal grieve on the inside of the outer shell and so on. The important concept here is that the bucket can be controlled as to its extension outside of the shell thereby controlling the rate at which burley is released.

To assist in the flow of water through the bucket it may be provided with slits 46 that accommodate the flow of water there through.

Further advantages and improvements may very well be made to the present invention without deviating from its scope. Although the invention has been shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus.

For example, the shell may not need to have an upper opening to accommodate the eye of the bucket, and the eye may extend from the shell. In addition, the top of the bucket may be removable allowing for the easier insertion of burley. Other embodiments may include other features such as being able to drive the bucket within the shell automatically to thereby control the amount of burley released. The pot may also include various apparatus such as instruments to measure the current flow and the temperature and that is relayed back to the fisherman.

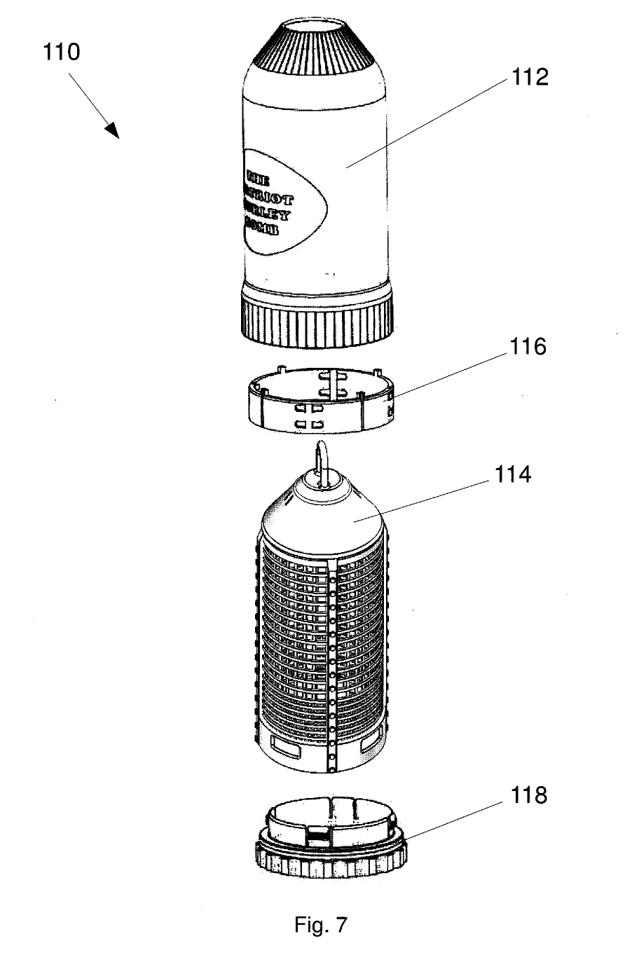

FIG. 7 shows a pot 110 according to a second embodiment of the invention. The pot 110 is of a different aspect ratio to the pot 10 and has corresponding components; outer covering shell 112, a burley bucket 114, a positioning or locking ring 116 and a closure cap 118.

It is readily understood that pots of a various sizes, shapes and aspect ratios are possible to cater for different materials to disperse as well as different dispersal quantities and rates.

In any claims that follow and in the summary of the invention, except where the context requires otherwise due to express language or necessary implication, the word “comprising” is used in the sense of “including”, i.e. the features specified may be associated with further features in various embodiments of the invention.

1. A burley pot for dispersing burley comprising an outer shell adapted to contain a burley bucket and a removable end cap to sealingly contain the bucket.

2. A burley pot as in claim 1 which includes an adjustment means for adjusting the rate at which burley is dispersed.

3. A burley pot as in claim 2 wherein the adjustment means comprises releasably fixing the bucket to the shell at various longitudinal intervals.

4. A burley pot as in claim 3 wherein said pot includes a locking ring that engages lugs extending from the bucket to thereby fix the bucket in relative longitudinal position to the outer shell.

5. A burley pot as in claim 1 wherein said pot includes an attachment means to accommodate the attachment of a rope and the like.

6. A burley pot as in claim 1 wherein said outer shell has a first end aperture that sealingly engages said bucket and a second end aperture that sealingly engages said end cap.

7. A burley pot as in claim 6 wherein the engagement of said end cap with said second end aperture causes engagement of said bucket with said first end aperture.
